(19) United States
(12) Patent Application Publication
(10) Pub. No.: US 2004/0108172 A1
(43) Pub. Date: Jun. 10, 2004

(54) Wheel locking chock

(75) Inventor: Robert Fox, Torrance, CA (US)

Correspondence Address: HAHN LOESER & PARKS, LLP, TWIN OAKS ESTATE, 1225 W. MARKET STREET, AKRON, OH, 44313, US

(73) Assignee: Norco Industries, Inc.

(21) Appl. No.: 10/310,200

(22) Filed: Dec. 4, 2002

(51) Int. Cl. B60T 3/00

(52) U.S. Cl. 188/32

(57) ABSTRACT

Embodiments of a wheel locking chock apparatus are disclosed for use with recreational vehicles, travel trailers, and boat trailers having single or tandem axles. The chock apparatus functions not only to hold a trailer in position, but to also limit the rocking or rotational movement of tire and wheel combination where a recreational vehicle or travel trailer is used for camping. The chock apparatus generally comprises a pair of metal chocks, which are movably linked together by a screw driven mechanism for tightening and loosening the chocks about the tread area of a single tire or those tires that are adjacent to one another. The wheel locking chock apparatus uses a drive mechanism having a centrally located rotatable, cylindrical adjusting member that is manually assisted for extending and contracting the chock assemblies.

### FIELD OF THE INVENTION

The present invention relates generally to a wheel chock apparatus, and more specifically to a locking apparatus that is suited for use with a single tire and wheel assembly included on single and dual axle vehicles such as recreational vehicles, tent trailers, travel trailers, boat trailers, and the like.

### BACKGROUND OF THE INVENTION

When vehicles with single or tandem axle wheels are to be parked in a selected location and expected to remain immoveable in fixed position until the occasion arises when they again expected to be mobile, some type of braking mechanism is needed. Such need becomes particular acute when the surface on which the vehicle is parked is other than level. Under circumstances where the vehicle is a trailer type vehicle, not supplied with a conventional braking arrangement, some form of blocking device for the wheels becomes necessary, whether the vehicle be supplied with only one wheel or with tandem axle wheels.

A variety of known wheel chock apparatus have been used to impose some degree of immobilization upon a single wheel of a vehicle by positioning a pair of generally wedged shaped chocks in contact with the leading and trailing circumferential rolling surface of the wheel, which is situated immediately in the front and rear area where the wheel makes contact with the surface over which it would otherwise be expected to travel. A potential disadvantage inherent with one of the designs of a known wheel chock is that an adjusting nut is not accessible enough to allow the chocks to be tightened into secure locking position. Another potential disadvantage with one of the designs of a known wheel chock is that tightening a handgrip by hand only may not provide the chock in a secure locking position with a single tire.

As shown in U.S. Pat. No. 4,828,076, one known wheel chock assembly for tandem axle wheels includes a pair of chocks positionable in spaced apart relation one to another that are connected together by a shaft that is affixed to the respective chocks. The apparatus is positioned between the wheels of tandem axles, where one chock is pushed to a blocking position against a front wheel and the other chock simultaneously pushed into a blocking position against the rear wheel. The wheel chocks are maintained in a locked position by an adjusting nut having a fixed attachment to the shaft substantially midway between opposite ends of the wheel chock.

As detailed in U.S. Pat. No. 6,425,465, another known wheel chock assembly used for locking a single tire, employs a pair of conventional wedge shaped chocks that are connected together by drive bores that are centrally connected to a handgrip that is used to tighten and loosen the chock assembly as relative to the tire and wheel assembly. Chock assemblies can be tightened by hand against the tire and wheel assembly and provide a certain level of stability according to the torque generated by the hands. Further tightening can be realized by applying to the handgrip an open-end wrench or adjustable wrench.

The foregoing illustrates limitations known to exist in present, single and dual wheel locking chocks. It is evident that a need exists for a wheel chock apparatus for both single and dual axle wheels that can easily and quickly be locked against the tire in a more stable and secure manner. Therefore, it is an object of the present invention to provide a new and useful wheel chock apparatus to fulfill these needs.

### SUMMARY OF THE INVENTION

It is therefore among the object of the invention to provide a new and improved lock chock assembly for single and tandem axle wheels which is of relatively simple construction and moreover having an infinite adjustment capability throughout a selected range.

The present invention is a locking wheel chock apparatus for use with recreation vehicles, tent trailers, travel trailers and boat trailers having single or dual tandem axles. The chock apparatus functions not only to hold a trailer in position, but also to limit the rocking and rotational movement of tire and wheel combination when a tent or travel trailer is used for camping. The chock apparatus comprises a pair of metal chock assemblies, which are moveably linked together by a drive mechanism for tightening and loosening the chock assemblies about the tread area of a single tire and a wheel assembly.

Another object of the invention is to provide a new and improved lock chock assembly comprising a pair of chocks having an extending and retracting inner connection comprising a single exteriorly threaded shaft. One chock of the pair of chock is attached to each end of the shaft. There is a means for rotating a rotatable adjusting member having a parallelity of circumferentially spaced apertures located on a radial surface of the rotatable adjusting member. The rotatable adjusting member is fixably attached to the shaft substantially midway between the opposite ends of the shaft. The rotatable adjusting member and the shaft are rotatable in a first direction for extension of the chocks and are rotatable in the opposite direction for retraction of the chocks.

Still another object of the invention is to provide a new and improved wheel locking chock assembly for tandem axle wheels in a front and rear alignment on one side of the vehicle comprising a pair of chocks having an extending and retracting interconnection comprising a single exteriorly threaded shaft. One chock of the pair of chocks is attached to each end of the shaft. There is a rotatable cylindrical adjusting member having at least three circumferentially spaced apertures located on a radial surface of the adjusting member. The rotatable adjusting member is fixably attached to the shaft substantially midway between opposite ends of the shaft. The adjusting member on the shaft is rotatable in a first direction for extension of the chocks and being rotable in opposite direction for retraction of the chocks. The shaft comprises a rod being attached to each end of the rotatable connector. A connector is attached to each chock and each rod engages a connector. At least one rod and one connector are threaded. A threaded rod engages a threaded connector. There is at least one chock comprised of a member of sheet material with two relatively flat sections bent with respect to each other providing adjacent sections in an acute fixed angular relationship whereby one flat section comprises a ground engaging section and the other flat section provides a wheel engaging section.

Still another object of the invention is to provide a method for chocking one or more tires. This is accomplished by providing a first chock assembly and a second chock assembly to engage one or more tires. The means for tightening and loosening the apparatus consist of a single threaded assembly moveably connecting the first chock assembly and the second chock assembly and a the third assembly comprised of a cylindrical, rotatable adjusting member. The rotatable adjusting member has a right-hand threaded rod attached to one end of the rotable adjusting member and a left-hand threaded rod attached to the other end of the rotable adjusting member. Each chock has a threaded connector, wherein the right-hand threaded rod engages one chock assembly threaded connector and the left-hand threaded rod engages the other chock assembly threaded connector. A handle shaft is inserted into an aperture located on the radial surface of the rotatable adjusting member. The shaft is rotated in a first direction until the first chock assembly and the second chock assembly are arranged in a proper configuration for one or more tires. The locking wheel chock apparatus is positioned until the first chock assembly and the chock assembly are proximal to one or more tires. The shaft is rotated in a second direction that is opposite the first direction, simultaneously moving the first chock assembly and the second chock assembly towards one another until the first chock assembly and the second chock assembly are tight against the tire.

For a better understanding of the present invention, together with other and further objects thereof, reference is made to the following description, taken in conjunction with the accompanying drawings, and its scope will be pointed out in the appending claims.

### BRIEF DESCRIPTION OF THE DRAWINGS

FIG. 1 is a side view of a first embodiment of the present invention of a dual wheel locking chock.

FIG. 2 is a perspective view of a second embodiment of the present invention of a dual wheel locking chock.

FIG. 3 is a top view of a third embodiment of a dual wheel locking chock.

FIG. 4 is a top view of a fourth embodiment of a wheel locking chock for use with a single tire.

FIG. 5 is an enlarged side view of the wheel locking chock shown in FIG. 4.

### DETAILED DESCRIPTION OF THE PREFERRED EMBODIMENTS

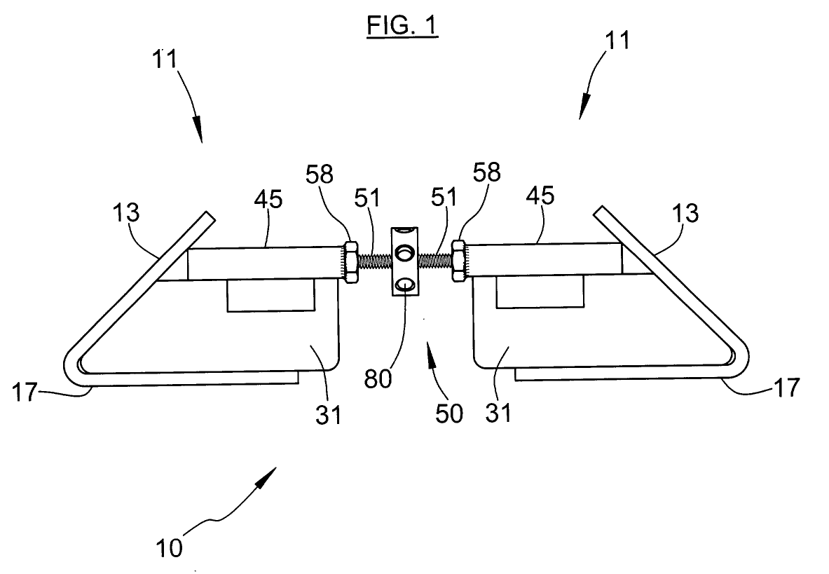

A lock chock for tandem axle wheels is shown in FIG. 1. Tandem axle wheel locking chock 10 is similar to the wheel locking chock described in U.S. Pat. No. 4,828,076, which is hereby incorporated by reference. Dual wheel locking chock 10 has two spaced chocks 11 that fit between two adjacently spaced tires of a dual axle trailer or recreational vehicle. A threaded operator is used to tighten and loosen the chocks 11 against the tires by moving the chocks away and toward one another.

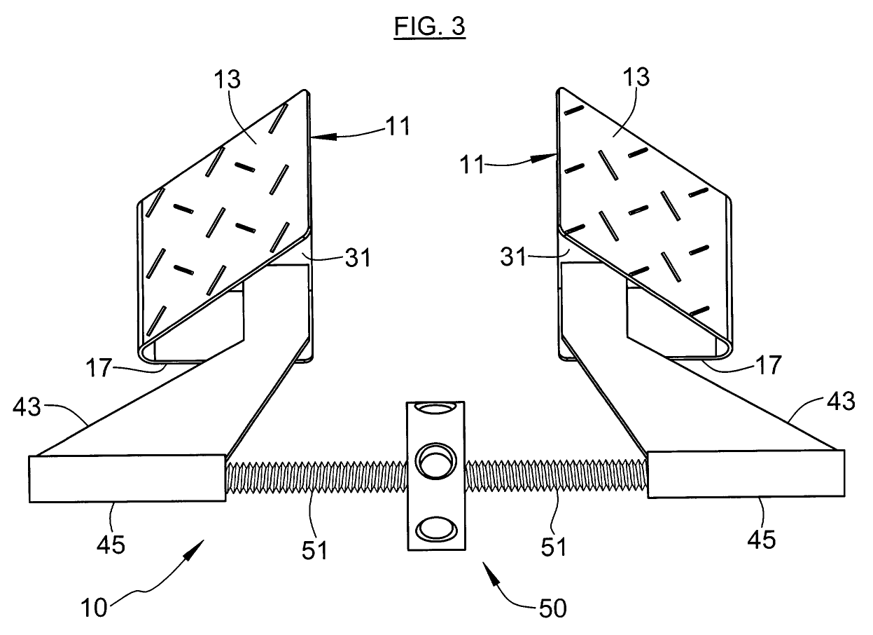

Each chock 11 has an inclined tire engaging surface 13 that bears against a tire. Other shapes, such as a curved surface that matches or approximates the curvature of tire may be used. Chocks 11 face away from each other towards tires. Each tire engaging surface 13 may have a non-slip checker pattern, similar to the one as shown in FIG. 3. Chock 11 has a wedge shaped formed by tire engaging surface 13 and base 17. A vertical wedge shaped reinforcing web 31 extends between base 17 and tire engaging surface 13 and is preferably welded to both base 17 and tire engaging surface 13.

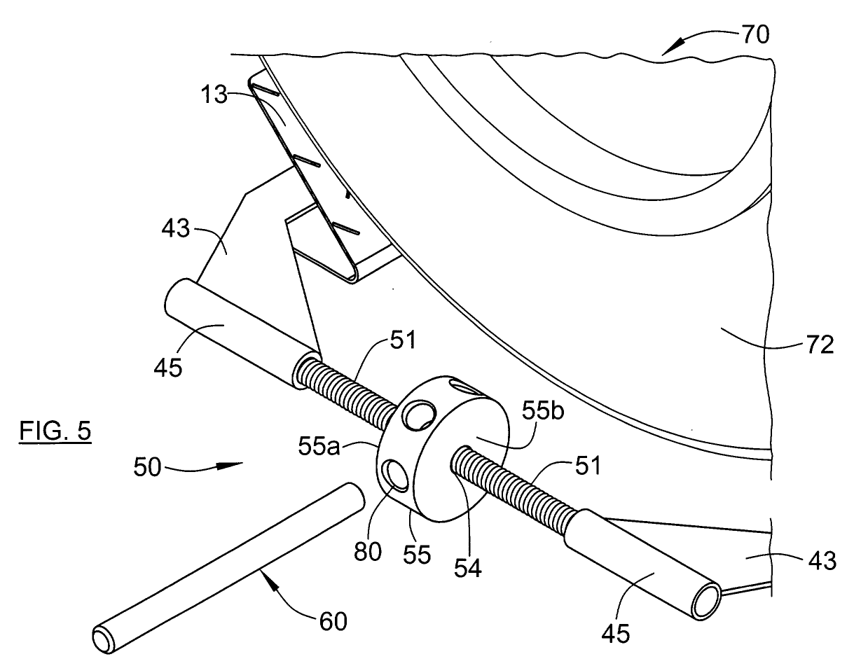

A threaded operator is used to tighten and loosen the chocks 11. The threaded operator consists of an rotatable adjusting member 50 having left hand threaded and right hand threaded rods 51 welded to adjusting member 50. Preferably adjusting member 50 has a cylindrical shape with a plurality of circumferentially spaced apart apertures 80 therein, which can be turned by a pole-like handle shaft (see FIG. 5 fitted into an aperture 80). Each threaded rod 51 extends into a tubular connector or sleeve 45.

The ends of the threaded shaft 51, after engagement with the corresponding nuts 58, are received into smooth bores of the corresponding sleeves 45. The nuts 58 are welded to tube 45. If desired, one of the chocks 11 can be removed from the threaded shaft 51, thereby making a smaller package for storage on the vehicle when not in active use.

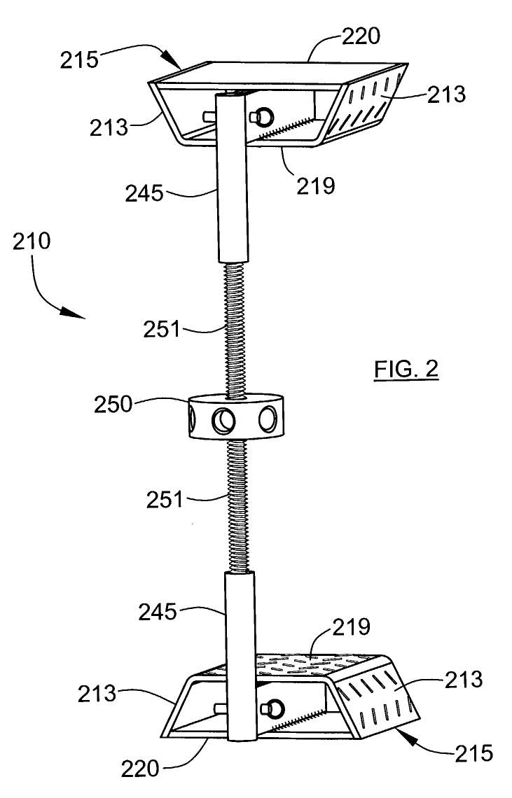

A dual wheel locking chock 210 is shown in FIG. 2. The dual wheel locking chock 210 has two vertically spaced chocks 215 that fit between two adjacently spaced tires of a dual axle trailer or recreational vehicle. A threaded operator is used to tighten the chocks 215 against the tires by moving the chocks 215 towards one another.

Each chock 215 has two spaced apart tire engaging surfaces 213 that bear against an adjacent tire. Each tire engaging surface 213 may have a non-slip checker pattern, as shown in FIG. 2. Preferably, each tire engaging surface 213 is inclined towards the adjacent tire. Other shapes, such as a curved surface that matches or approximates the curvature of a tire may be used. Chock 215 may have an open trapezoidal shape formed by four sides (first surface 220, second surface 219, and tire engaging surfaces 213). Preferably, chock 215 is removably attached to the threaded operator.

A threaded operator is used to vertically tighten and loosen the chocks 215. The threaded operator consists of a rotatable adjusting member 250 having left hand threaded 253 and right hand threaded rods 251 welded to the rotatable adjusting member 250. Preferably, the rotatable adjusting member 250 has a cylindrical shape, which can be turned by a pole-like handle shaft (see FIG. 5). Each threaded rod 251, 253 extends into a tubular threaded connector 245, one having right hand threads and one having left hand threads. Chocks 215 are laterally offset from a longitudinal axis extending through the threaded operator (250, 251, 253, 245).

FIG. 3 shows an alternate embodiment of dual wheel locking chock. Dual wheel locking chock 10 is similar to the single wheel locking chock described in U.S. Pat. No. 6,425,465, which is hereby incorporated by reference. Dual wheel locking chock 10 has two spaced chocks 11 that fit between two adjacently spaced tires of a dual axle trailer or recreational vehicle. A threaded operator is used to tighten the chocks 11 against the tires by moving the chocks away from one another.

Each chock 11 has an inclined tire engaging surface 13 that bears against a tire. Other shapes, such as a curved surface that matches or approximates the curvature of tire may be used. Chocks 11 face away from each other towards tires. Each tire engaging surface 13 may have a non-slip checker pattern, as shown in FIG. 3. Chock 11 has a wedge shaped formed by tire engaging surface 13 and base 17. A vertical wedge shaped reinforcing web 31 extends between base 17 and tire engaging surface 13 and is preferably welded to both base 17 and tire engaging surface 13. A laterally extending tab 43 extends from a threaded connector 45 and is welded to reinforcing web 31.

A threaded operator is used to tighten and loosen the chocks 11. The threaded operator consists of an rotatable adjusting member 50 having left hand threaded and right hand threaded rods 51 welded to adjusting member 50. Preferably adjusting member 50 has a cylindrical shape, which can be turned by a pole-like handle shaft (not shown). Each threaded rod 51 extends into a tubular threaded connector 45, one having right hand threads and one having left hand threads. The laterally extending tabs 43 extend from a longitudinal axis extending through the threaded operator (50, 51, 45). This allows the dual wheel locking chock to be used with tire spacing that is too narrow to allow the chock operator to fit between the tires.

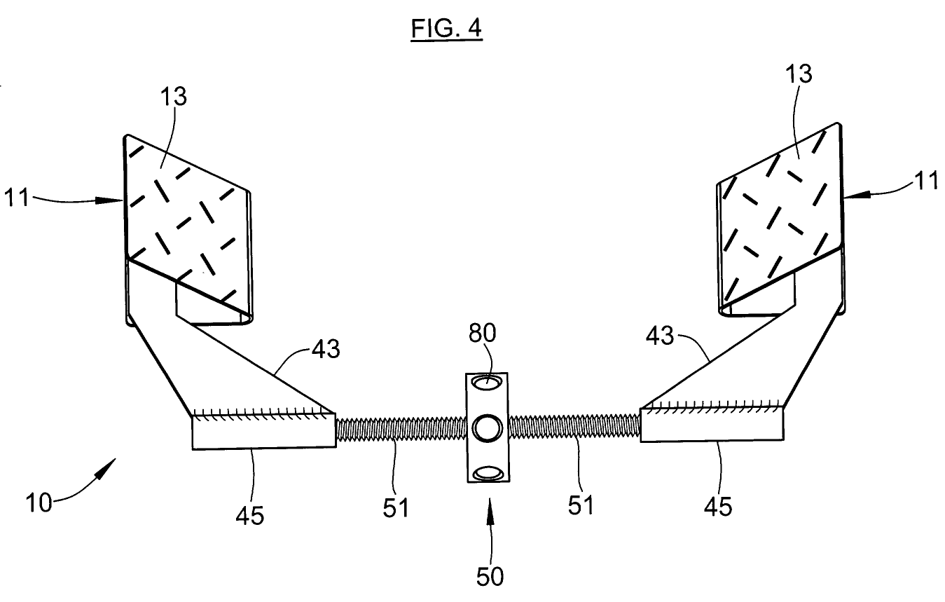

Reversing the attachment of chocks 11 and the laterally extending tabs 43, such that the chocks 11 face each other and tabs 43 extend away from adjusting member 50 would form a locking wheel chock 10 that could be used with a single tire as shown in FIG. 4, similar to the locking chock described in U.S. Pat. No. 6,425,465. The wheel chock 10 is generally comprised of a two metal chock assemblies 11 both of which are movably linked together by a rotatable adjusting member 50 for tightening and loosening the chock assemblies 11 about the tread area of a single tire and wheel assembly 70 such as that which is indicated in FIG. 5. As shown in FIG. 4, the chock assemblies 11 are situated respectively at first and second opposing ends of the threaded operator 50 and are oriented relative to one another in a spatially separated manner such that the inclined regions 13 of each chock assembly 11 face each other.

As most clearly shown in FIG. 5, the threaded operator 50 is comprised of a centrally located rotatable adjusting member 55 which preferably is cylindrical and has apertures 80 located on its radial surface. Additionally, the threaded operator 50 includes a left hand threaded and right hand threaded rods 51. The threaded rods 51 are received by a first, longitudinally extending central bore (not shown) provided in a first end 55a of the adjusting member 55, and similarly received by a second, longitudinally extending central bore 54 provided in a second end 55b of the adjusting member 50. The threaded rods 51 are immovably secured in the bores by welding or other suitable means. The threaded rods 51 are matingly compatible with the threads provided on the internal surface of the tubular members 45. As also indicated in FIG. 4, the outermost end of the threaded rods 51 are threadably received by the internally threaded orifice of the tubular members 45.

The wheel chock apparatus 10, as detailed in FIG. 4, will be used with a single tire and wheel assembly as shown in FIG. 5. The tire engaging surface 13 of one of the chock assemblies 11 will be placed beneath the generally downwardly facing portion of the tread of the tire 72, that lies to the left of the area where the tire 72 makes contact with an underlying support surface such as pavement. The tire engaging surface 13 of the other chock assembly 11 will be placed under the generally downwardly facing portion of the tread of the tire 72, that lies to the right of the area where the tire 72 makes contact with the underlying support surface. The chock assemblies 11 will then be drawn laterally inward toward the tread of the tire by rotating the adjusting member 55 about its longitudinal axis. Initially, the desired inward movement of the chock assemblies 11 may be produced by turning the adjusting member 55 with a pole-like handle shaft 60 inserted into one of the apertures 80 located on the radial surface until the tire engaging surfaces 13 make direct contact with the aforementioned downwardly directed tread areas of the tire 72. Additional inward movement and tightening can be accomplished by application of the handle shaft 60 into other apertures on the adjusting member 55 as shown in FIG. 5.

While particular embodiments of the present invention has been shown and described, it will be obvious to those skilled in the art that changes and modifications may be made without departing from the invention in it broader aspects, and, therefore, the aims of its appended claims are to cover all such changes and modifications as they fall within the scope of this invention.

What is claimed is:

1. A wheel locking chock apparatus in alignment on one side of a vehicle comprising:
a pair of chocks having an extending and retracting interconnection comprising a single exteriorly threaded shaft;
one chock of the pair of chocks being attached to each end of the shaft; and
a means for rotating a rotatable adjusting member having a plurality of circumferentially-spaced apertures located on a radial surface of the rotatable adjusting member; the rotatable adjusting member being fixably attached to the shaft substantially midway between opposite ends of the shaft; and the rotatable adjusting member and the shaft being rotatable in a first direction for extension of the chocks and being rotatable in an opposite direction for retraction of the chocks.

2. The wheel locking chock apparatus according to claim 1, wherein the shaft comprises a rod being attached to each end of the rotatable connector, and further comprises a connector attached to each chock, each rod engaging a connector, at least one rod being threaded, at least one connector being threaded, and a threaded rod engaging a threaded connector.

3. The wheel locking chock according to claim 1, wherein the rotatable adjusting member is cylindrical.

4. The wheel locking chock according to claim 1, wherein the rotatable adjusting member further comprises at least three apertures located on the radial surface.

5. The wheel locking chock according to claim 1, wherein at least one aperture extends radially inward into the adjusting member.

6. The wheel locking chock according to claim 1, further comprising wherein a handle shaft removably positioned into at least one of the apertures of the rotatable adjusting member and rotated to effectively tighten or loosen the chocks.

7. A wheel locking chock apparatus for tandem axle wheels in the front and the rear alignment on one side of a vehicle comprising:
a pair of chocks having an extending and retracting interconnection comprising;
a rotatable, cylindrical adjusting member having at least three circumferentially-spaced apertures located on a radial surface of the adjusting member; the rotatable adjusting member being fixably attached to the shaft substantially midway between opposite ends of the shaft; and the adjusting member and the shaft being rotatable in a first direction for extension of the chocks and being rotatable in an opposite direction for retraction of the chocks; and
a rod being attached to each end of the rotatable connector, and further comprises a connector attached to each chock, each rod engaging a connector, at least one rod being threaded, at least one connector being threaded, and a threaded rod engaging a threaded connector;
each chock comprising a member of sheet material with two relatively flat sections bent with respect to each other providing adjacent sections in an acute fixed angular relationship whereby one flat section comprises a ground-engaging section and the other flat section provides a wheel-engaging section.

8. A method for chocking one or more tires comprising:
providing a first chock assembly and a second chock assembly to engage one or more tires; means for tightening and loosening the apparatus, the means consisting of a single threaded assembly movably connecting the first chock assembly and the second chock assembly, the threaded assembly comprising: a cylindrical, rotatable adjusting member; a right hand threaded rod attached to one end of the rotatable adjusting member; a left hand threaded rod attached to the other end of the rotatable adjusting member, each chock having a threaded connector, the right hand threaded rod engaging one chock assembly threaded connector the left hand threaded rod engaging the other chock assembly threaded connector;
a first step of rotating the shaft until the first chock assembly and the second chock assembly are arranged in a proper configuration for the one or more tires;
positioning the locking wheel chock apparatus until the first chock assembly and the second chock assembly are proximal to one or more tires;
inserting a handle shaft into an aperture located on the radial surface of said rotatable adjusting member; and
a second step of rotating the shaft simultaneously moving the first chock assembly and second chock assembly towards the one or more tires until the first chock assembly and the second chock assembly are tight against the one or more tires.

9. The method according to claim 8, wherein the second step of rotating the shaft simultaneously moving the first chock assembly and second chock assembly towards the one or more tires until the first chock assembly and the second chock assembly are tight against the one or more tires comprises rotating the shaft in a predetermined rotation;
removing the handle shaft;
inserting the handle shaft into another aperture; and
repeating the steps of rotating, removing, and inserting the handle shaft until the first chock assembly and the second chock assembly are tight against the one or more tires.
